(19) United States
(12) Patent Application Publication
(10) Pub. No.: US 2012/0268064 A1
(43) Pub. Date: Oct. 25, 2012

(54) Inductively Rechargeable Portable Charger

(75) Inventors: Anthony Phillip Ostrom, Greenwood, IN (US); Elizabeth Harrison Meyer, Chicago, IL (US)

(73) Assignee: POWERMAT USA, LLC, Commerce Township, MI (US)

(21) Appl. No.: 13/089,397

(22) Filed: Apr. 19, 2011

(51) Int. Cl. H02J 7/00

(52) U.S. Cl. 320/108

(57) ABSTRACT

A portable charger is provided. The portable charging includes a housing and a power source located in the housing so that that the power source can be inductively recharging through the housing. The portable charger also includes a first output connector coupled to the power source for charging a first electronic device, as well as a second output connector coupled to the power source that is different from the first output connector for charging a second electronic device. The first output connector and the second output connector are configured to be at least partially stored within the housing in order to minimize size of the charger.

### TECHNICAL FIELD

Various embodiments relate to a portable charger for recharging electronic devices in which the portable charger is rechargeable inductively.

### BACKGROUND

It is common for people to interact with many portable electronic devices every day. Increasingly, people are accumulating portable electronic devices such as mobile phones, MP3 players, global positioning system (GPS) electronics, digital cameras as well as a number of other portable devices. As demand for these portable devices increases, the devices become more multifunctional and are independently capable of mobile communication. Additionally, as electronic devices become more portable, the trend is to become smaller, lighter and more compact.

Each of these portable electronic devices needs power. And the trends to make smaller, faster and smarter portable electronic devices create a challenge of providing enough power in a smaller package. Portable electronic devices are typically powered by rechargeable power sources such as batteries. Each portable electronic device typically has its own plug-in charger which can be plugged into to an external power source in order to keep the battery and portable electronic device sufficiently charged. By using their portable electronic devices continuously, people find themselves having to find a power outlet to plug in their portable electronic devices to a charger or external power source at home, at the office, and even places in between, such as at airports.

Having many of these power chargers can be a hassle for people to take with them everywhere in order to recharge their portable electronic devices when needed. Or alternatively, people may have multiple plug-in chargers which they leave at convenient locations. However, having multiple plug-in chargers is wasteful. In addition, leaving a charger plugged into an outlet and never unplugging it wastes energy. Even when people have multiple chargers, portable electronic devices often run down and lose charge at inconvenient times where when no charger is available, or where there are no outlets or external power source to plug in a charger.

### SUMMARY

According to one embodiment, a portable charger is provided. The portable charging includes a housing and a power source located in the housing so that that the power source can be inductively recharging through the housing. The portable charger also includes a first output connector coupled to the power source for charging a first electronic device, as well as a second output connector coupled to the power source that is different from the first output connector for charging a second electronic device.

Another embodiment provides a portable charger including a housing and a power source located in the housing so that that the power source can be inductively recharging through the housing. The portable charger has a first output connector coupled to the power source and a second output connector coupled to the power source. The first output connector and the second output connector are configured to be at least partially stored within the housing in order to minimize size of the charger.

According to yet another embodiment, a portable charger is provided. The portable charger includes a housing formed by pair of shells joined to each other to define an opening and a track. An inductive coil is also located in the housing. A power source is coupled to the inductive coil the power source being inductively rechargeable therethrough. The power source and inductive coil and stacked upon each other so that the power source and inductive coil overlap each other within the housing in order to minimize the size of the housing. A first output connector is coupled to the power source in order to charge a first electronic device. The first output is moveable through the opening formed in the housing between a retracted position and an extended position such that in the retracted position, the first output connector is retracted at least partially within the housing. An actuator having a biasing member moves the first output connector to the extended position when the biasing member is actuated. A second output connector which is different from the first output connector is adapted for charging a second device. The second output is coupled to the power source with a tether so that the second output connector is adapted to be stored within the track. The portable charger is adapted to charge the first device and the second device without being connected to an external power source.

### BRIEF DESCRIPTION OF THE DRAWINGS

FIG. 1 illustrates a perspective view of a portable charger according to an embodiment;

FIG. 2 is another perspective view of the portable charger of FIG. 1 where the connectors are in the stored position;

FIG. 3 is another perspective view of the portable charger of FIG. 1 where an connector is extended;

FIG. 4 illustrates an exploded perspective view of the portable charger of FIG. 1; and

FIG. 5 illustrates another exploded view of the portable charger of FIG. 1.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

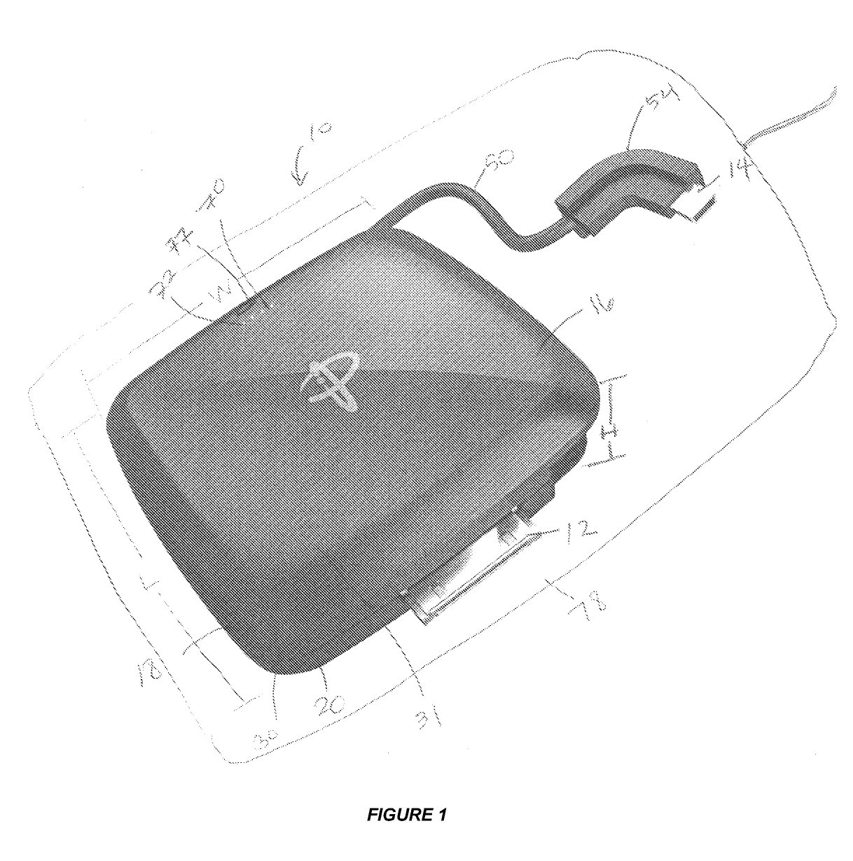

Referring now to the Figures, FIG. 1 shows a portable charger 10 according to an embodiment. The portable charger 10 allows people to wirelessly recharge multiple electronic devices. The portable charger 10 eliminates the need to plug in each portable electronic device individually with separate chargers. Further, the portable charger 10 prevents having to carry around multiple chargers for each electronic device.

The portable charger 10 is adapted to charge two electronic devices. Therefore, the portable charger 10 may include a first output connector 12 as well as a second output connector 14. The portable charger 10 may be adapted to charge two different devices; therefore, the first output connector 12 may be different than the second output connector 14.

In one embodiment, the first output connector 12 may be an Apple® dock thirty-pin connector such as those that are adapted to connect to Apple-products such as an iPad, iPhone, iPod or any other electronic device adapted to connect to a thirty-pin connector. As illustrated, the second output connector 14 may be a micro-universal serial bus (USB) connector. The micro-USB connector may be a standardized size for connecting with such as mobile phones, digital cameras or other various electronic devices. It is also contemplated that the first output connector 12 and second output connector 14 may be another standardized connector for connecting with popular electronic devices. Therefore, the portable charger 10 may be used with virtually all currently marketed mobile electronic devices.

The first output connector 12 and second output connector 14 may be housed in a housing 16. The portable charger 10 allows two electronic devices to be charged at the same time through the first output connector 12 and the second output connector 14 without being connected to an external power source. The power source 22 is rechargeable inductively through the housing 16.

The housing 16 may be generally compact so that it may easily be carried in a persons's purse or pocket, for example. By being compact, the portable charger 10 may be easily carried anywhere so that electronic devices can be wirelessly recharged without needing a plug or individual charger. In one embodiment, the housing 16 may have a width W, a length L, and a height H where the width and the length may be generally equal to each other. The width and the length may be less than 3 inches. In another embodiment, the width and length may be approximately 2.75 inches. The height of the housing 16 may be less than 1 inch. In another embodiment, the height of the housing 16 may be less than 1 inch. In another embodiment, the height may be approximately 0.69 inches. As such, the height is approximately one-quarter the size of the width and length dimensions.

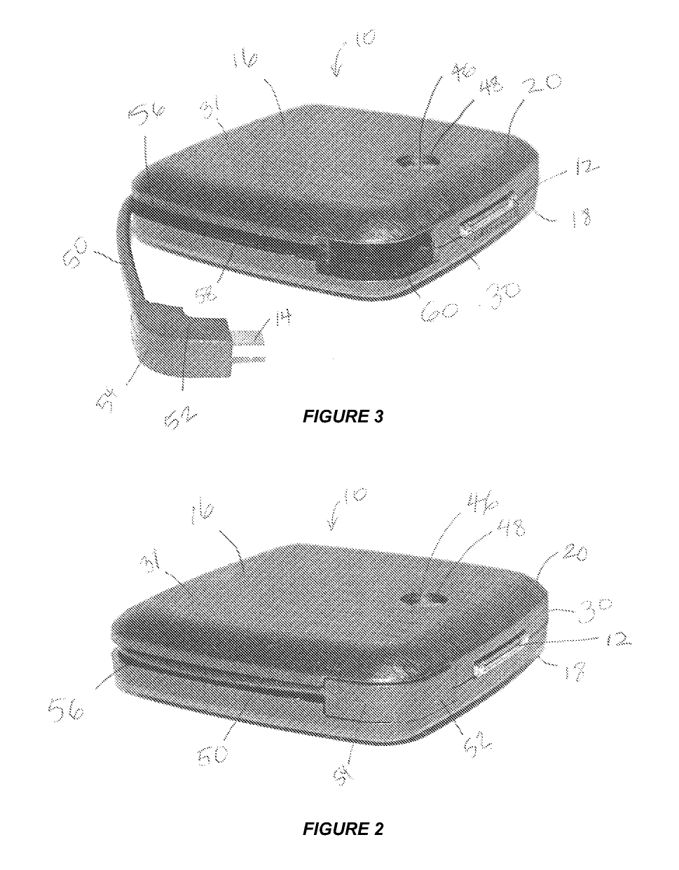

As illustrated in FIG. 2, the housing 16 is compact a configures to store the first output connector 12 and second output connector 14 in a compact storage configuration so that the connectors 12, 14 do not extend beyond the width, length or height of the housing 16. In the compact storage configuration, the connectors 12, 14 are protected from being damaged or collecting debris while being stored within the housing 16. Further, the connectors 12, 14 do not add to the overall dimensions of the housing 16 in the compact storage configuration. As shown in FIG. 3, the connectors 12, 14 are adapted to be extended and deployed from the housing in order to be utilized to recharge various electronic devices.

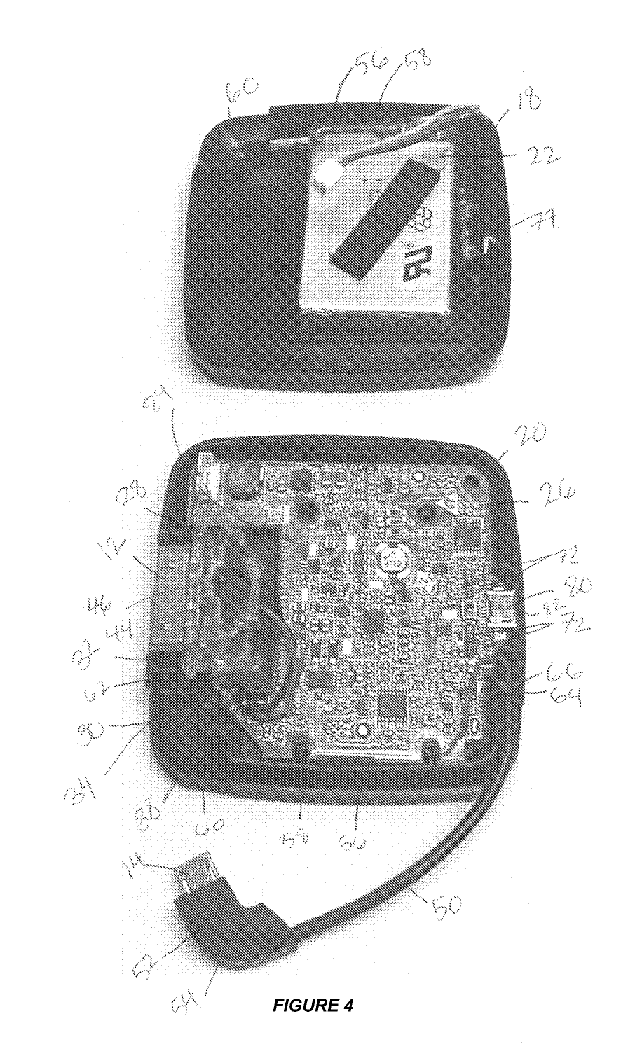

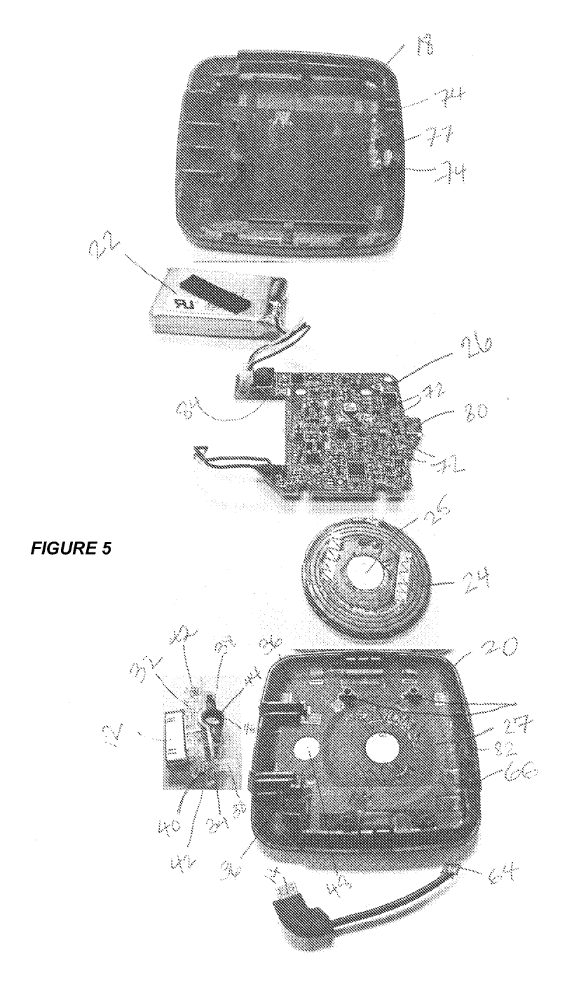

Turning now to FIG. 4 and FIG. 5, the components housed within the shells 18, 20 of the housing 16 are illustrated in greater detail. The housing 16 may be formed of a pair of shells 18, 20 as further illustrated in FIGS. 4 and 5. The first shell 18 and the second shell 20 may be joined together to form the enclosed housing 16. The first shell 18 and second shell 20 may be joined together with a snap fit or any other suitable joining method such as welding or fasteners, for example. The first shell 18 and the second shell 20 may be formed of plastic by injection molding or any other suitable process.

The housing 16 includes a power source 22. The power source 22 may be a rechargeable power pack such as a rechargeable battery. The rechargeable power source 22 may be a rechargeable battery such as nickel-cadmium, nickel-metal hydride, lithium-ion, alkylide or any other suitable rechargeable battery. The power source 22 may have an electric charge capacity of approximately 1850 milliamp-hours (mAh). In another embodiment, the power source may have a greater electric charge capacity such as 2500 mAh or any suitable electric charge capacity in order to recharge an electronic device through the output connectors 12, 14.

The housing 16 also includes an inductive coil 24 and a circuit board 26 coupled to the power source 22. In order to minimize the height of the housing 16, the power source 22, the inductive coil 24, and the circuit board 26 may be stacked upon each other and overlap in the height direction. In one embodiment, the power source 22 is mounted to the first shell 18 of the housing 16. The power source 22 may be mounted to the first shell 18 with an adhesive or any other suitable fastening mechanism. In another embodiment, the inductive coil 24 and circuit board 26 are joined to each other and mounted to the second shell 20 of the housing 16. The inductive coil 24 may be joined to the circuit board 26 with solder or connected by wire so that the inductive coil and circuit board are in electrical communication. The inductive coil 24 is wrapped around a ferromagnetic core 25 and is connected to the power source 22 through the circuit board 26. The inductive coil 24 and the circuit board 26 may be further joined with adhesive or any other suitable fastening mechanism. Alternatively, the inductive coil 24 may be attached to the second shell 20 with adhesive or other suitable fastening mechanisms such as a press fit in an indentation 27 in the second shell 20, for example.

The housing 16 may also include an actuator assembly 28 for extending the first output connector 12. The actuator assembly 28 allows the first output connector 12 to move between a retracted position as illustrated in FIGS. 2 and 4 to an extended position as shown in FIG. 1. In the retracted position, the first output connector 12 is at least partially retracted within the housing 16. In another embodiment, in the retracted position the first output connector 12 may not extend beyond a peripheral surface 30 of the housing 16 as illustrated in FIG. 4.

The actuator assembly 28 may include a sliding member 32 to which the first output connector 12 is mounted. The sliding member 32 may be formed of plastic such that the sliding member is over-molded with the first output connector 12. Alternatively, the sliding member 32 may be mounted to the output connector 12 by any suitable fastening means such as welding or soldering.

The actuator assembly 28 further includes a mounting member 34 which remains generally stationary and which the sliding member 32 and first output connector 12 slide with respect to the mounting member 34. The mounting member 34 is secured to the second shell 20. The mounting member 34 may be secured to the second shell with receptacles 36 formed in the second shell 20 which receive the mounting member 34. Alternatively, the mounting member 34 may be integrally formed with the second shell 20. The sliding member 32 may include a pair of posts 38 which slide with respect to openings 40 formed in the mounting member 34. A pair of biasing members 42 may be disposed between the sliding member 32 and the mounting member 34 in order to resiliently bias movement of the first output connector 12. Alternatively, the biasing members 42 may be located along the posts 38.

The actuator assembly 28 further includes a button assembly 44. The button assembly 44 includes a button 46 which may be actuated through a button opening 48 formed in the housing 16. The button assembly 44 may also include a biasing member (not shown) in order to bias the button 46 so that the button 46 is generally level with an outer surface 31 of the housing 16. The button 46 may be actuated in a direction which is generally perpendicular to the travel of the first output connector 12.

In the retracted position, the first output connector 12 is spring loaded so that the biasing members 42 are compressed. When the button assembly 44 is actuated, the sliding member 32 is released so that the sliding member 32 and first output connector 12 are extended in a linear direction from the housing 16 to an extended position. In the extended position, the first output connector 12 may be connected to an electrical device.

The second output connector may be coupled to the housing 16 with a tether 50. The tether 50 may be generally flexible but may also include a rigid connection portion 52 to which the second output connector 14 is mounted. The connection portion 52 may be formed of plastic such that the connection portion 52 is over-molded with the second output connector 14. In a storage position as shown in FIG. 2, the second output connector 14 and the tether 50 may be stored at least partially within the housing 16 and the connection portion 52 may include a contoured surface portion 54 which is adapted to align with the peripheral surface 30 of the housing 16. The contoured surface 54 may be generally parallel to the peripheral surface 30 of the housing so that when the second output connector 14 is stored within the housing 16, the contoured surface 54 forms a portion of the peripheral surface 30 of the housing 16.

The tether 50 and the connection portion 52 may be stored in a track 56 formed along a peripheral surface 30 of the housing 16. The track 56 may be formed by a first recess portion 58 adapted to store the tether 50 and a second recess 60 being larger than the first recess 58 for storing the connection portion 52. The first recess 58 and the second recess 60 may be sized to retain the tether 50 and the connection portion 52, respectively. In another embodiment, the track 56 may be formed between the first shell 18 and the second shell 20. The tether 50 and the connection portion 52 may be visible in the track 56 when in the storage position; and the second output connector 14 may be located in a third recess 62 so that the second output connector 14 is concealed from view. By being concealed from view in the storage position, the second output connector 14 is protected from damage or collecting debris while in the third recess 62.

The tether 50 may also include a plug portion 64 in order to connect the tether 50 to the housing 16. The plug portion 64 may be attached to a receptacle 66 formed in the second shell 20. The plug portion may be attached with a snap-fit or press-fit to the receptacle 66 or may be attached with any suitable fastening mechanism.

The first output connector 12 and second output connector 14 are in electrical communication with the battery power source 22. The first output connector 12 may be connected to the power source 22 through wiring which may run through the sliding member 32 and be connected to the circuit board 26. Likewise, the second output connector 14 may be in communication with the battery 22 through the circuit board 26 by wiring that runs from the second output connector 14 through the connection portion 52 and tether 50 to the circuit board 26.

The portable charger 10 further includes a charge indicator 70 which displays the level of charge available in the power source 22. The charge indicator 70 may include a plurality of lights which correspond to the level of charge depending on the number of lights illuminated. In one embodiment, the charge indicator 70 may include light emitting diodes (LEDs) 72. In another embodiment, the charge indicator 70 may include at least four LEDs 72. The LEDs 72 may be mounted on the circuit board 26 and connected to the housing 16 with a plurality of light pipes 74. The light pipes 74 may extend between the LEDs 72 and the housing 16 in order to transmit the light from the LEDs 72 so that the light is visible outside the housing 16. The charge indicator 70 may be illuminated when the power source 22 is recharging and turn off in order to indicate when the recharging is complete. Alternatively, the housing 16 may include a charge indicator button 76 which, when pressed, will actuate the LEDs 72 corresponding to the level of charge of the power source 22. The indicator button 76 may be actuated through an indicator button opening 77 formed in the first shell 18. The indicator button 76 may not extend beyond an outer surface 31 of the housing 16. In an alternate embodiment, the indicator button may be level with the outer surface 31 of the housing 16 so that the indicator button 76 forms a portion of the outer surface 31.

The power source 22 is electrically coupled to the inductive coil 24 so that the power source 22 may be recharged inductively through the housing 16. In order to be recharged inductively, the inductive coil 24 is placed in the vicinity of an external inductive charger 78 which has an external inductive coil thereby creating a magnetic flux linkage between the external coil and the inductive coil 24 in the charger 10 by which power is transferred from the external coil to the inductive coil 24 which is then stored in the power source 22.

Where no external inductive charger is available, the power source 22 may also be recharged through an external power connector 80. The external power connector 80 may be adapted to connect to a micro-USB input connector in order to connect to an external power source. The external power connector 80 may be mounted to the circuit board 26 or may be connected directly to the power source 22 in any other suitable method. The external power connector 80 may be generally located inside the housing 16 and may accessed through an aperture 82 formed in the first shell 18 of the housing 16. The external power connector 80 may be generally located opposite the first output connector 12 in the length direction of the housing 16.

In order to minimize the size of the housing, the power source 22 of the circuit board 26 in the inductive coil 24 may be stacked in the height direction. The first output connector 12 may be located at a position adjacent the stack of the power source 22, the inductive coil 24, and the circuit board 26 in the length direction. The circuit board 26 may include a cut-out 84 so that the first output connector 12 may retract fully into the housing 16 so that the first output connector 12 does not extend beyond a peripheral surface 30 when in the retracted position. The actuator assembly 28 may be located in the cut-out region 84. The housing 16, as illustrated, is generally rectangular, however, any suitable shape is contemplated for the compact housing 16.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A portable charger comprising:
a housing;
a power source disposed in the housing inductively recharging therethrough;
a first output connector coupled to the power source; and
a second output connector coupled to the power source that is different from the first output connector.

2. The charger according to claim 1 further comprising a tether connecting the second output connector to the power source, wherein the second output connector is deployable from a stored position.

3. The charger according to claim 2 wherein the housing further comprises a track formed along an outer peripheral surface, wherein in the stored position, the tether and the second output connector are stored in the track.

4. The charger according to claim 1 further comprising an actuator for moving the first output connector between a first retracted position and a second extended position, wherein in the retracted position, the first output connector is retracted at least partially with the housing.

5. The charger according to claim 4 wherein in the retracted position the first output connector is disposed at least partially within the housing and adjacent the power source in in order to minimize the size of the housing.

6. The charger according to claim 3 wherein the actuator further comprises a biasing member that moves the first output connector to an extended position when the actuator is actuated.

7. The charger according to claim 1 wherein the first output connector is adapted to connect to a thirty-pin connector.

8. The charger according to claim 1 wherein the second charging output is adapted to connect to a micro-universal serial bus (USB) connector.

9. The charger according to claim 1 further comprising a charge indicator display in electrical communication with the power source.

10. The charger according to claim 1 wherein the charge indicator further comprises a plurality of light emitting diodes (LEDs).

11. A portable charger comprising:
a housing;
a power source disposed in the housing, the power source being inductively rechargeable therethrough;
a first output connector coupled to the power source; and
a second output connector coupled to the power source,
wherein the first output connector and the second output connector are configured to be at least partially stored within the housing in order to minimize size of the charger.

12. The charger according to claim 10 further comprising an inductive coil and a circuit board in the housing; wherein at least a portion of the power source, the inductive coil and the circuit board are stacked upon each other thereby overlapping within the housing in order to minimize the size of the housing.

13. The charger according to claim 12 wherein the housing has a length and a width and a height, such that the power source, the inductive coil and the circuit board are stacked in the vertical direction, the first output connector located adjacent the power source, the inductive coil and the circuit board in at least one of the width or length direction in order to minimize the size of the housing.

14. The charger according to claim 11 further comprising an actuator for moving the first output connector between a first retracted position and a second extended position wherein the actuator further comprises a button operable to move the first connector to the extended position through an opening formed along a peripheral surface of the housing when the button is actuated.

15. The charger according to claim 10 further comprising a track formed along a peripheral surface of the housing, the second output connector further comprising a tether connecting the second output connector to the power source, wherein the second output connector is deployable with the tether from a stored position, such that in the stored position, the tether and the second output connector are stored in the track.

16. The charger according to claim 10 wherein the housing comprises a pair of shells which are joined to each other to define an opening and a track, wherein the first output connector is moveable through the opening between a retracted position and an extended position, the second output connector adapted to be stored within the track.

17. The charger according to claim 16 further comprising an inductive coil and a circuit board coupled to the power source, wherein the inductive coil is disposed in one of the shells proximate an outer surface through which the inductive coil recharges the power source, the circuit board and power source stacked upon the inductive coil and overlapping within the housing.

18. The charger according to claim 10 wherein the second output connector is different from the first output connector.

19. The charger according to claim 10 further comprising an input connector wherein the power source is rechargeable by an external power source through the input connector.

20. The portable charger comprising:
a housing formed by a pair of shells joined to each other to define an opening and a track;
an inductive coil disposed in the housing;
a power source coupled to the inductive coil and stacked upon each other thereby overlapping within the housing in order to minimize the size of the housing, the power source being inductively rechargeable therethrough;
a first output connector coupled to the power source adapted for charging a first device, the first output being moveable through the opening between a retracted position and an extended position such that in the retracted position, the first output connector is retracted at least partially within the housing;
an actuator having a biasing member that moves the first output connector to the extended position when the biasing member is actuated; and
a second output connector different from the first output connector adapted for charging a second device, the second output coupled to the power source with a tether, wherein the second output connector is adapted to be stored within the track,
wherein the charger is adapted to charge the first device and the second device without being connected to an external power source.
